(19) United States
(12) Patent Application Publication
(10) Pub. No.: US 2015/0324083 A1
(43) Pub. Date: Nov. 12, 2015

(54) Touch-screen Display Device

(71) Applicant: Shenzhen China Star Optoelectronics Technology Co. Ltd., Shenzhen, Guangdong (CN)

(72) Inventor: Chengliang YE, Shenzhen, Guangdong (CN)

(73) Assignee: Shenzhen China Star Optoelectronics Technology Co. Ltd., Shenzhen, Guangdong (CN)

(21) Appl. No.: 14/235,084

(22) PCT Filed: Jan. 9, 2014
(86) PCT No.: PCT/CN2014/070373

§ 371 Date: Jan. 27, 2014

(30) Foreign Application Priority Data
Dec. 31, 2013 (CN) 201310752222.4

(51) Int. Cl. G06F 3/0488; G02B 27/22

(52) U.S. Cl. CPC G06F 3/0488; G02B 27/22

(57) ABSTRACT

The present invention relates to a touch screen display device which includes a protective plate; a first sensor, disposed under the protective plate; a second sensor disposed under the first sensor, and dielectric to the first sensor; and a three-dimensional display converting substrate disposed under the second sensor. The touch-screen display device utilizes a film-type patterned retarder, FPR, to serve as a deposit substrate of the first and second sensors so as to reduce a thickness of the touch-screen device as well as the manufacturing cost.

### CROSS REFERENCE

This application also related to National Stage Application No.: (Attorney Docket No. CM14008), submitted on the same date, entitled, “Touch-Screen Display Device” assigned to the same assignee.

### FIELD OF THE INVENTION

The present invention relates to a display device, and more particularly, to a touch-screen display device capable of fulfilling three dimensions (3-D) display.

### DESCRIPTION OF PRIOR ART

Touch-screen display device is a display device incorporated with a touch-sensing panel such that the display panel can provide an interactive operation through touching movement detectable by the touch-screen panel. Currently, touch-screen display device made form liquid crystal display is the most popular to the customer. According to its configuration, the touch-screen display panel can be categorized into resistive type, capacitive, surface acoustic, and touch styles. Among those four types, the capacitive type is most popular since it requires no pressure to generate signals. In addition, after the production, there is no need of calibration or only need to perform once. It features prolong service life. Accordingly, it has been developed quickly in recently year.

FIG. 1 is a configurational and illustrational view of a prior art capacitive touch-screen display panel. Referring to FIG. 1, the capacitive touch-screen display panel of prior art includes a touch-screen panel 1, and a liquid crystal display module 2 located under the touch-screen panel 1.

The touch-screen panel 1 includes a protective glass 11, a first sensor 12, a first sensor substrate 13, a second sensor 14, and a second sensor substrate 15. The first sensor 12 (for example, an indium tin oxides, ITO), the second sensor substrate 13 (for example, polyethylene terephthalate, PET), the first sensor 14 (for example, an ITO), and the second sensor substrate 15 (for example, a PET) are disposed and arranged under the touch-screen panel 1. In the current technology, in order to deposit the first and second sensors 12, 14, the first and second sensor substrates 13 and 15 have to be disposed firstly. Not only will this cause additional manufacturing cost, but will also increase the thickness of the touch-screen display device.

### SUMMARY OF THE INVENTION

In order to resolve the existing technical issue encountered by the prior art, it is an object of the present invention to provide a touch screen display device in which not only can it display three-dimensional image, but also can it reduce the manufacturing cost.

For the object stated above, according to one aspect of the present invention, a touch screen display device which includes a liquid crystal display panel, and a touch screen panel disposed onto the liquid crystal display panel, and wherein the touch screen panel includes a protective plate; a first sensor, disposed under the protective plate; a second sensor disposed under the first sensor, and dielectric to the first sensor; and a three-dimensional display converting substrate disposed under the second sensor.

Wherein the three-dimensional display converting substrate is a film-type patterned retarder.

Wherein the first sensor is a touch-sensing electrode, and the second sensor is a touch-driving electrode.

Wherein the first sensor and second sensor are interengaged with each other through adhesive layer on their ends such that the first and second sensors are dielectric from each other with air.

Wherein the first sensor and second sensor are interengaged with each other by an adhesive layer.

Wherein an insulative layer is arranged between the first sensor and second sensor such that the first and second sensors are dielectric with each other.

Wherein the touch screen display device further includes a flexible printed circuit board having one end interconnected to a motherboard for receiving power supply, and having dual-connection arrangements on the other end, wherein one of the dual-connection arrangements is interconnected to the first sensor, and the other of the dual-connection arrangements is connected to the second sensor.

According to another aspect of the present invention, a touch screen display device is provided and which includes a liquid crystal display panel, and a touch screen panel disposed onto the liquid crystal display panel, wherein the touch screen panel includes a protective plate; a first sensor and a second sensor disposed under the protective plate and dielectrically arranged with each other; and a three-dimensional display converting substrate disposed under the first and second sensors.

Wherein the three-dimensional display converting substrate is a film-type patterned retarder.

Wherein the first and second sensors are electrically interconnected to a motherboard through a flexible printed circuit board for receiving power supply.

Wherein the first sensor is a touch-sensing electrode, and the second sensor is a touch-driving electrode, or alternatively, the first sensor is a touch driving circuit, and the second sensor is the touch-sensing electrode.

By the provision of the present invention, not only does the realization of three-dimensional display be realized, but also reduces the manufacturing cost. In addition, the overall thickness of the touch-screen display device is reduced.

### BRIEF DESCRIPTION OF DRAWINGS

FIG. 1 is a configurational and illustrational view of a prior art capacitive touch-screen display panel;

FIG. 2 is a configurational and illustrational view of a touch-screen display panel made in accordance with a first embodiment of the present invention;

FIG. 3 is a configurational and illustrational view of a touch-screen display panel made in accordance with a second embodiment of the present invention;

FIG. 4 is a configurational and illustrational view of a touch-screen display panel made in accordance with a third embodiment of the present invention; and

FIG. 5 is a configurational and illustrational view of a touch-screen display panel made in accordance with a fourth embodiment of the present invention.

### DETAILED DESCRIPTION OF PREFERRED EMBODIMENTS

Detailed description will be given to the illustrational embodiments of the present invention along with the accompanied drawings in which the embodiments are shown. However, it should be noted that many different embodiments can be implemented, and the present invention should not be construed as being limited to the embodiments only. To the contrary, by the illustration of the preferred embodiments in full and complete manner, the spirit and scope of the present invention can be completely conveyed to the skilled in the art. In the accompanied drawings, same numeral reference will be used to represent the same element through out the specification.

FIG. 2 is a configurational and illustrational view of a touch-screen display panel made in accordance with a first embodiment of the present invention.

Referring to FIG. 2, the touch-screen display panel made in accordance with a first embodiment of the present invention includes a touch-screen panel 10, a liquid crystal display 20.

According to the first preferred embodiment of the present invention, the touch screen display panel 10 includes a protective plate 101, a first sensor 102, a second sensor 103, and a three-dimensional display converting substrate 104. The protective plate 101 can be a glass substrate and is located on top of the touch screen display panel 10 to protect the first sensor 102 which is disposed right under the protective plate 101. The second sensor 103 is disposed under the first sensor 102. The first and second sensors 102, 103 are interengaged with each other by an adhesive layer 105 along its ends, i.e. the insulative layer 105 surrounds the perimeters of the first and second sensors 102, 103. By this arrangement, the first and second sensors 102, 103 are isolated from the air. The three-dimensional display converting substrate 104 is disposed under the second sensor 103. In the current embodiment, the three-dimensional display converting substrate 104 is a film-type patterned retarder, FPR. By the provision of the three-dimensional display converting substrate 104, the touch screen display device made in accordance with the first embodiment can readily display the three-dimensional display. However, the present invention should not be limited thereto. Because the three-dimensional display converting substrate 104 uses the film-type patterned retarder as its substrate, the first and second sensors 102, 103 can use it as a deposit substrate, i.e. the first and second sensors 102, 103 can directly deposit onto the three-dimensional display converting substrate 104. By this arrangement, there is no need to deposit a polyethylene terephthalate, PET, over the three-dimensional display converting substrate 104 for the deposition of the first and second sensors 102, 103. Accordingly, the realization of the three-dimensional display and the reduction of the manufacturing cost can be achieved in the same time, and the overall thickness of the touch screen display device can be reduced.

In addition, in the current embodiment, the first sensor 102 can be served as a touch-sensing electrode to detect the touching movement of a user, and it can be made from metal from an alloy configured with copper, niobium, chrome, or an alloy configured from silver, platinum, and copper, or molybdenum, aluminum, or indium tin oxide ITO), etc. The second sensor 103 can be served as a touch-sensing driving electrode to trigger a working command corresponding to the finger movement of the user performed on the first sensor 102. It can be made from metal from an alloy configured with copper, niobium, chrome, or an alloy configured from silver, platinum, and copper, or molybdenum, aluminum, or indium tin oxide ITO), etc.

The liquid crystal display 20 made in accordance with a first embodiment of the present invention includes an upper polarized film 201, a color filter substrate 202, a liquid crystal layer 203, a thin film transistor array substrate 204, a lower polarized film 205, a backlight module 206. The upper polarized film 201 is disposed on top of color filter substrate 202. The color filter substrate 202 can also be referred to as CF, and it generally includes a transparent substrate, such as a glass substrate, and black patterns or images arranged on the transparent substrate, a color photo-resistors layer, such as R, G and B filter film with patterns or images, and an alignment layer. The liquid crystal layer 203 is disposed between the color filter substrate 202 and the thin film transistor array substrate 204. The thin film transistor array substrate 204, which is arranged onto the color filter substrate 202 is also referred to as TFT substrate, and which generally includes a transparent substrate (such as a glass substrate), and a plurality of thin film transistors arranged in array. The lower polarized film 205 is disposed below the thin film transistor array substrate 204, and the backlight module 206 is disposed under the lower polarized film 205 for mainly providing light source. The thin film transistor array substrate 204 provides driving voltage to the liquid crystal molecules in the liquid crystal layer 203 so as to align the liquid crystal molecules in a way that the light beam from the backlight module 206 can pass through the liquid crystal layer 203. As a result, images or patterns can be displayed onto the liquid crystal display 20 with the corporation of the color filter substrate 202.

It should be pointed out that according to the first embodiment of the present invention, the touch-screen display device further includes a flexible printed circuit board 301 which has one end interconnected to a motherboard 302 for getting power supply, and having a dual-connection arrangement on the other end. Wherein one of the dual-connection arrangements is interconnected to the first sensor 102, and the other of the dual-connection arrangement is connected to the second sensor 103. In addition, the motherboard 302 is further interconnected to a driving chip (not shown in the drawings) arranged within the thin film transistor array substrate 204.

In addition, in assembling, the touch-screen panel 10 and the liquid crystal display 20 can be configured together with an adhesive layer (not shown in Figures). However, the present invention will not be limited thereto.

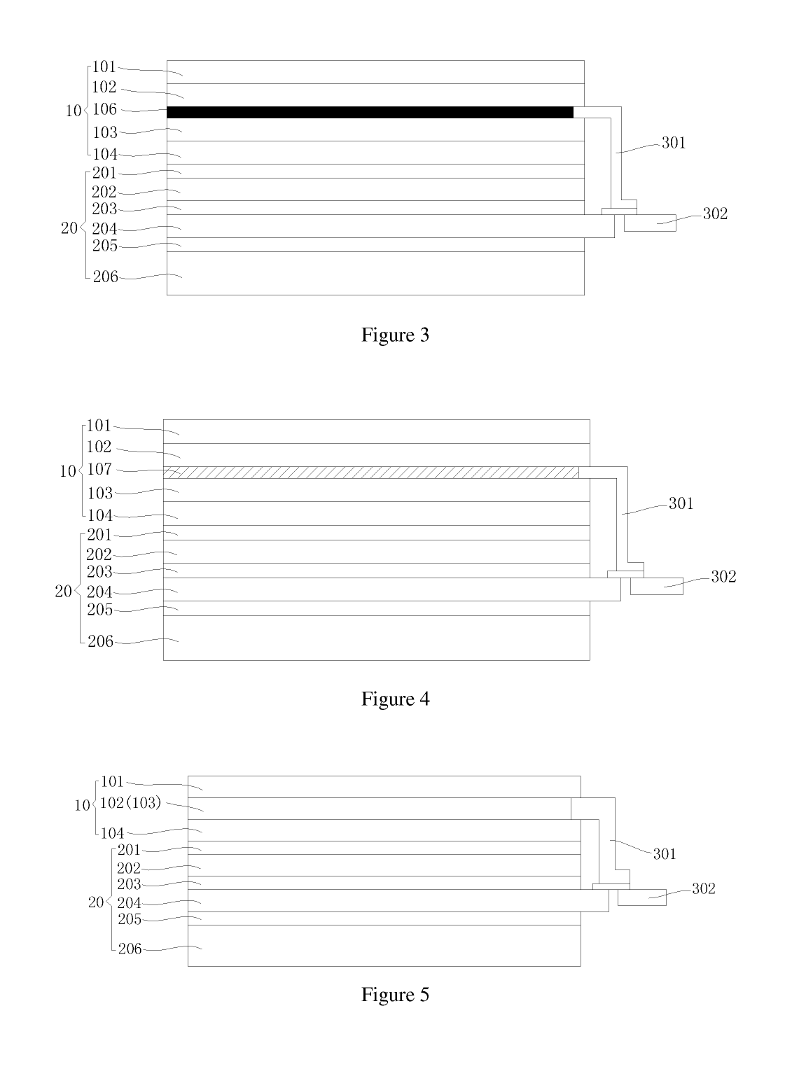

FIG. 3 a configurational and illustrational view of a touch-screen display panel made in accordance with a second embodiment of the present invention.

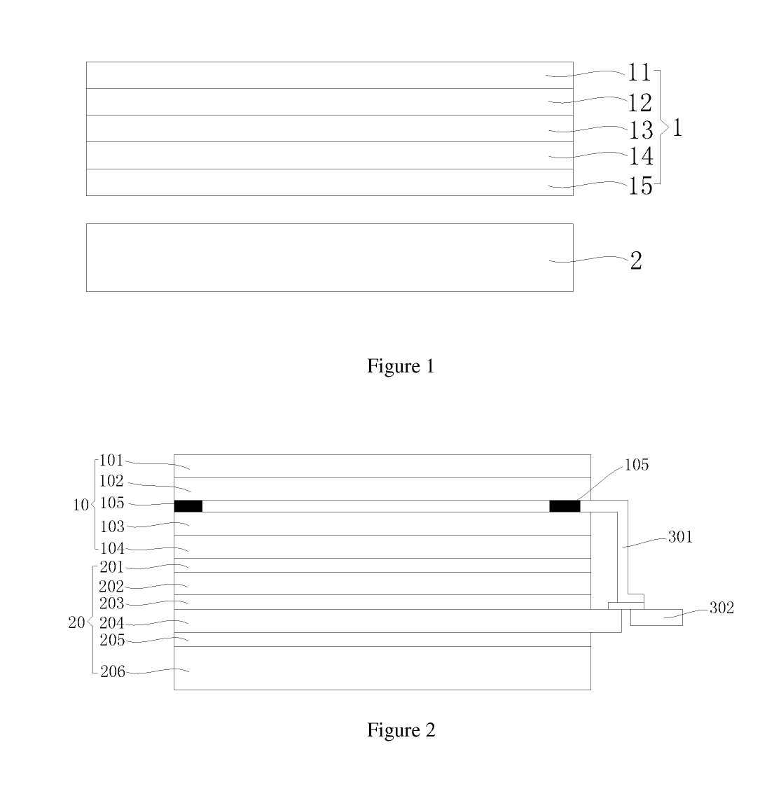

Referring to FIG. 3, a configurational and illustrational view of a touch-screen display panel made in accordance with a second embodiment of the present invention is shown. The difference between the touch-screen display devices shown in FIGS. 1 and 3 is the second sensor 103 is disposed under the first sensor 102, and an adhesive layer 106 arranged between the first and second sensors 102, 103, i.e. the space between the first and second sensors 102, 103 are completed filled by the adhesive layer 106. In the current embodiment, the adhesive layer 106 is dielectric such that the first and second sensors 102, 103 are dielectrically arranged with each other.

It should be pointed out that according to the first embodiment of the present invention, the touch-screen display device further includes a flexible printed circuit board 301 which has one end interconnected to a motherboard 302 for getting power supply, and having a dual-connection arrangement on the other end. Wherein one of the dual-connection arrangements is interconnected to the first sensor 102, and the other of the dual-connection arrangement is connected to the second sensor 103. In addition, the motherboard 302 is further interconnected to a driving chip (not shown in the drawings) arranged within the thin film transistor array substrate 204. When the touch-screen panel 10 and the liquid crystal display 20 can be configured together with an adhesive layer (not shown in Figures). However, the present invention will not be limited thereto.

FIG. 4 a configurational and illustrational view of a touch-screen display panel made in accordance with a third embodiment of the present invention.

Referring to FIG. 4, a configurational and illustrational view of a touch-screen display panel made in accordance with a third embodiment of the present invention is shown. The difference between the touch-screen display devices shown in FIGS. 2 and 3 are the second sensor 103 is disposed under the first sensor 102, and an insulative layer 107 arranged between the first and second sensors 102, 103. The insulative layer 107 is made from SiNx, SiOx or the combination thereof. With the provision of the insulative layer 107, the space between the first and second sensors 102, 103 are completed filled so as to make the first and second sensors 102, 103 completely isolated with each other. In addition, in the current embodiment, the insulative layer 107 can be attached to the first and second sensors 102, 103 respectively.

Similarly, according to the typical embodiment of the present invention, the touch-screen display device further includes a flexible printed circuit board 301 which has one end interconnected to a motherboard 302 for getting power supply, and having a dual-connection arrangement on the other end. Wherein one of the dual-connection arrangements is interconnected to the first sensor 102, and the other of the dual-connection arrangement is connected to the second sensor 103. In addition, the motherboard 302 is further interconnected to a driving chip (not shown in the drawings) arranged within the thin film transistor array substrate 204. When the touch-screen panel 10 and the liquid crystal display 20 can be configured together with an adhesive layer (not shown in Figures). However, the present invention will not be limited thereto.

FIG. 5 is a configurational and illustrational view of a touch-screen display panel made in accordance with a fourth embodiment of the present invention.

Referring to FIG. 5, the touch-screen display panel made in accordance with a first embodiment of the present invention includes a touch-screen panel 10, a liquid crystal display 20.

According to the fourth preferred embodiment of the present invention, the touch screen display panel 10 includes a protective plate 101, a first sensor 102, a second sensor 103, and a three-dimensional display converting substrate 104. The protective plate 101 can be a glass substrate and is located on top of the touch screen display panel 10. The first and second sensors 102, 103 are disposed under the protective plate 101 so as to configure a multi-point contact touch structure. However, since it is a prior art known to the skilled in the art, not detailed description is given herebelow. The first and second sensors 102, 103 are dielectrically interengaged with each other. The three-dimensional display converting substrate 104 is disposed under the second sensor 103. In the current embodiment, the three-dimensional display converting substrate 104 is a film-type patterned retarder, FPR. By the provision of the three-dimensional display converting substrate 104, the touch screen display device made in accordance with the first embodiment can readily display the three-dimensional display. However, the present invention should not be limited thereto. Because the three-dimensional display converting substrate 104 uses the film-type patterned retarder as its substrate, the first and second sensors 102, 103 can use it as a deposit substrate, i.e. the first and second sensors 102, 103 can directly deposit onto the three-dimensional display converting substrate 104. By this arrangement, there is no need to deposit a polyethylene terephthalate, PET, over the three-dimensional display converting substrate 104 for the deposition of the first and second sensors 102, 103. Accordingly, the realization of the three-dimensional display and the reduction of the manufacturing cost can be achieved in the same time, and the overall thickness of the touch screen display device can be reduced.

In addition, in the current embodiment, the first sensor 102 can be served as a touch-sensing electrode to detect the touching movement of a user, and it can be made from metal from an alloy configured with copper, niobium, chrome, or an alloy configured from silver, platinum, and copper, or molybdenum, aluminum, or indium tin oxide ITO), etc. The second sensor 103 can be served as a touch-sensing driving electrode to trigger a working command corresponding to the finger movement of the user performed on the first sensor 102. It can be made from metal from an alloy configured with copper, niobium, chrome, or an alloy configured from silver, platinum, and copper, or molybdenum, aluminum, or indium tin oxide ITO), etc. The present invention should not be limited thereto, for example, the first sensor 102 can be used as a touch-sensing driving electrode, while the second sensor 103 is used as a touch-sensing electrode.

The liquid crystal display 20 made in accordance with a fourth embodiment of the present invention includes an upper polarized film 201, a color filter substrate 202, a liquid crystal layer 203, a thin film transistor array substrate 204, a lower polarized film 205, a backlight module 206. The upper polarized film 201 is disposed on top of color filter substrate 202. The color filter substrate 202 can also be referred to as CF, and it generally includes a transparent substrate, such as a glass substrate, and black patterns or images arranged on the transparent substrate, a color photo-resistors layer, such as R, G and B filter film with patterns or images, and an alignment layer. The liquid crystal layer 203 is disposed between the color filter substrate 202 and the thin film transistor array substrate 204. The thin film transistor array substrate 204, which is arranged onto the color filter substrate 202 is also referred to as TFT substrate, and which generally includes a transparent substrate (such as a glass substrate), and a plurality of thin film transistors arranged in array. The lower polarized film 205 is disposed below the thin film transistor array substrate 204, and the backlight module 206 is disposed under the lower polarized film 205 for mainly providing light source. The thin film transistor array substrate 204 provides driving voltage to the liquid crystal molecules in the liquid crystal layer 203 so as to align the liquid crystal molecules in a way that the light beam from the backlight module 206 can pass through the liquid crystal layer 203. As a result, images or patterns can be displayed onto the liquid crystal display 20 with the corporation of the color filter substrate 202.

It should be pointed out that according to the first embodiment of the present invention, the touch-screen display device further includes a flexible printed circuit board 301 which has one end interconnected to a motherboard 302 for getting power supply, and having a dual-connection arrangement on the other end. Wherein one of the dual-connection arrangements is interconnected to the first sensor 102, and the other of the dual-connection arrangement is connected to the second sensor 103. In addition, the motherboard 302 is further interconnected to a driving chip (not shown in the drawings) arranged within the thin film transistor array substrate 204.

In addition, in assembling, the touch-screen panel 10 and the liquid crystal display 20 can be configured together with an adhesive layer (not shown in Figures). However, the present invention will not be limited thereto.

In summary, according to the embodiment of the present invention, the touch-screen display device utilizes a film-type patterned retarder, FPR, to serve as a deposit substrate of the first and second sensors so as to reduce a thickness of the touch-screen device as well as the manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A touch screen display device, including a liquid crystal display panel, and a touch screen panel disposed onto the liquid crystal display panel, the touch screen panel including:
a protective plate;
a first sensor, disposed under the protective plate;
a second sensor disposed under the first sensor, and dielectric to the first sensor; and
a three-dimensional display converting substrate disposed under the second sensor.

2. The touch screen display device as recited in claim 1, wherein the three-dimensional display converting substrate is a film-type patterned retarder.

3. The touch screen display device as recited in claim 1, wherein the first sensor is a touch-sensing electrode, and the second sensor is a touch-driving electrode.

4. The touch screen display device as recited in claim 2, wherein the first sensor is a touch-sensing electrode, and the second sensor is a touch-driving electrode.

5. The touch screen display device as recited in claim 3, wherein the first sensor and second sensor are interengaged with each other through adhesive layer on their ends such that the first and second sensors are dielectric from each other with air.

6. The touch screen display device as recited in claim 4, wherein the first sensor and second sensor are interengaged with each other through adhesive layer on their ends such that the first and second sensors are dielectric from each other with air.

7. The touch screen display device as recited in claim 3, wherein the first and second sensors are interengaged with each other by an adhesive layer.

8. The touch screen display device as recited in claim 4, wherein the first and second sensors are interengaged with each other by an adhesive layer.

9. The touch screen display device as recited in claim 3, wherein an insulative layer is arranged between the first and second sensors such that the first and second sensors are dielectric with each other.

10. The touch screen display device as recited in claim 4, wherein an insulative layer is arranged between the first and second sensors such that the first and second sensors are dielectric with each other.

11. The touch-screen display device as recited in claim 1, further including a flexible printed circuit board having one end interconnected to a motherboard, and having dual-connection arrangements on the other end, wherein one of the dual-connection arrangements is interconnected to the first sensor, and the other of the dual-connection arrangements is connected to the second sensor.

12. The touch-screen display device as recited in claim 2, further including a flexible printed circuit board having one end interconnected to a motherboard, and having dual-connection arrangements on the other end, wherein one of the dual-connection arrangements is interconnected to the first sensor, and the other of the dual-connection arrangements is connected to the second sensor.

13. A touch screen display device, including a liquid crystal display panel, and a touch screen panel disposed onto the liquid crystal display panel, the touch screen panel including:
a protective plate;
a first sensor and a second sensor disposed under the protective plate and dielectrically arranged with each other; and
a three-dimensional display converting substrate disposed under the first and second sensors.

14. The touch screen display device as recited in claim 13, wherein the three-dimensional display converting substrate is a film-type patterned retarder.

15. The touch screen display device as recited in claim 13, wherein the first and second sensors are electrically interconnected to a motherboard through a flexible printed circuit board for receiving power supply.

16. The touch screen display device as recited in claim 13, wherein the first sensor is a touch-sensing electrode, and the second sensor is a touch driving electrode, or alternatively, the first sensor is a touch driving circuit, and the second sensor is the touch-sensing electrode.

17. The touch screen display device as recited in claim 14, wherein the first sensor is a touch-sensing electrode, and the second sensor is a touch driving electrode, or alternatively, the first sensor is a touch driving circuit, and the second sensor is the touch-sensing electrode.

18. The touch screen display device as recited in claim 15, wherein the first sensor is a touch-sensing electrode, and the second sensor is a touch driving electrode, or alternatively, the first sensor is a touch driving circuit, and the second sensor is the touch-sensing electrode.
